(19) United States
(12) Patent Application Publication
(10) Pub. No.: US 2018/0046656 A1
(43) Pub. Date: Feb. 15, 2018

(54) CONSTRUCTING FILTERABLE HIERARCHY BASED ON MULTIDIMENSIONAL KEY

(71) Applicant: MICROSOFT TECHNOLOGY LICENSING, LLC, Redmond, WA (US)

(72) Inventors: Muiris Woulfe, Dublin (IE); Poornima Muthukumar, Dublin (IE); Yuanyuan Dong, Dublin (IE)

(73) Assignee: MICROSOFT TECHNOLOGY LICENSING, LLC, Redmond, WA (US)

(21) Appl. No.: 15/236,370

(22) Filed: Aug. 12, 2016

(51) Int. Cl. G06F 17/30

(52) U.S. Cl. CPC G06F 17/30333; G06F 17/30466; G06F 17/30867; G06F 17/3033; G06F 17/30589

(57) ABSTRACT

Multidimensional key based construction of a filterable hierarchy is provided. A data service initiates operations to construct the hierarchy by joining current node-key elements with an element delimiter into a current node string. Child node elements are also joined with the element delimiter into child node string(s). The child node string(s) are further encapsulated with nesting delimiter(s) and the resulting string is concatenated to the current node string. Next, parent node elements are joined with the element delimiter. The current node-key is generated by concatenating the parent node string to the current node string (that includes the child node string(s)) with a parent delimiter. The current node-key is inserted into a representation for the current node within a data structure.

### BACKGROUND

Information collection, management, and analysis have changed work processes and associated data management. Automation and improvements in work processes have expanded scope of capabilities offered by businesses. With the development of faster and smaller electronics, execution of mass processes at data analysis systems have become feasible. Indeed, analysis work at data centers, data warehouses, data workstations have become common business features in modern work environments. Such systems execute a wide variety of applications ranging from enterprise resource management applications to data management tools. Many such applications process data analysis to attempt to improve consumption of big data. Big data gathering and analysis consumes significant resources and performance at a promise of improved processes and condensed task flows.

Data analysis techniques are becoming ever more important as big data grows in popularity across the computer industry. Variety of techniques are necessary for analyzing large data quantities found in big data, to facilitate mining of the relevant insights, and (ultimately) to deliver the benefit of relevant insights to customers. There are currently significant gaps within data analysis methods employed when dealing with hierarchical data. Lack of relevant data analysis methods lead to underutilization of collected hierarchical data.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to constructing a filterable hierarchy based on a multidimensional key. A data service, according to embodiments, may initiate operations to construct the filterable hierarchy upon receiving a request to generate a current node-key for a current node stored within a data store. Next, current node elements of the current node may be joined with an element delimiter into a current node string. Child node elements of child node(s) of the current node may also be joined with the element delimiter into child node string(s). The child node string(s) may be encapsulated with nesting delimiter(s) and concatenated to the current node string. Furthermore, parent node elements of a parent node of the current node may be joined with the element delimiter into a parent node string. A current node-key may be generated by concatenating the parent node string to the current node string with a parent delimiter. The current node-key may be inserted into a representation for the current node within a data structure.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A through 1B are conceptual diagrams illustrating examples of constructing a filterable hierarchy based on a multidimensional key, according to embodiments;

FIG. 2 is a display diagram illustrating example components of a data service that constructs a filterable hierarchy based on a multidimensional key, according to embodiments;

FIG. 3 is a display diagram illustrating components of a scheme to construct a filterable hierarchy based on a multidimensional key, according to embodiments;

FIG. 4 is a display diagram illustrating tabular data structures that store keys and components used to represent a node of a data store, according to embodiments;

FIG. 5 is a simplified networked environment, where a system according to embodiments may be implemented;

FIG. 6 is a block diagram of an example computing device, which may be used to construct a filterable hierarchy based on a multidimensional key, according to embodiments; and

FIG. 7 is a logic flow diagram illustrating a process for constructing a filterable hierarchy based on a multidimensional key, according to embodiments.

### DETAILED DESCRIPTION

As briefly described above, a data service may construct a filterable hierarchy with a multidimensional key. In an example scenario, the data service may receive a request to generate a current node-key for a current node that is stored within a data store. The current node-key may include elements of a parent node, the current node, and child node(s) that are concatenated with delimiters. Initially, current node elements of the current node may be joined with an element delimiter into a current node string. The element delimiter may include a vertical bar character, among others.

Next, child node elements of child node(s) of the current node may be joined with the element delimiter into child node string(s). The child node string(s) may also be encapsulated with nesting delimiter(s) and concatenated to the current node string. A nesting delimiter may include a bracket character, a braces character, and/or similar ones. A number of the nesting delimiter(s) used to encapsulate the child node string(s) may be correlated to a number of level(s) between the child node(s) and the current node.

Furthermore, parent node elements of a parent node of the current node may be joined with the element delimiter into a parent node string. The current node-key may be generated by concatenating the parent node string to the current node string with a parent delimiter. The parent delimiter may include a hyphen character, among others. Alternative character(s) (that are not found in the current node string, the child string, and/or the parent node string) may be selected to serve as delimiter(s) if the element delimiter, the nesting delimiter(s), and/or the parent delimiter are detected within the current node string, the child string, and/or the parent node string. Furthermore, a character selected as a delimiter (which may be found in the strings) may be used as the delimiter(s) as long as the selected character is replaced with another character (not found in the strings) before adding as delimiter(s) (for example, replace a hyphen character found in the strings with an underscore character and use the hyphen character as a delimiter). The replacement operation may also not fundamentally alter a structure of the strings (for example, a letter in the strings may not be replaced with another letter). Additionally, the current node-key may be inserted into a representation for the current node within a data structure. The data structure may include a table in which a row may represent the current node.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to construct a filterable hierarchy based on a multidimensional key. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display, a non-visual display (for impaired users as an example), and/or other user experience associated with an application or service through which a user interacts with the application or service. A user action refers to an interaction between a user and a user experience of an application or a user experience provided by a service that includes touch input, gesture input, voice command, eye tracking, gyroscopic input, pen input, mouse input, and/or keyboards input, among others. An application programming interface (API) may be a set of routines, protocols, and tools for an application or service that enable the application or service to interact or communicate with one or more other applications and services managed by separate entities.

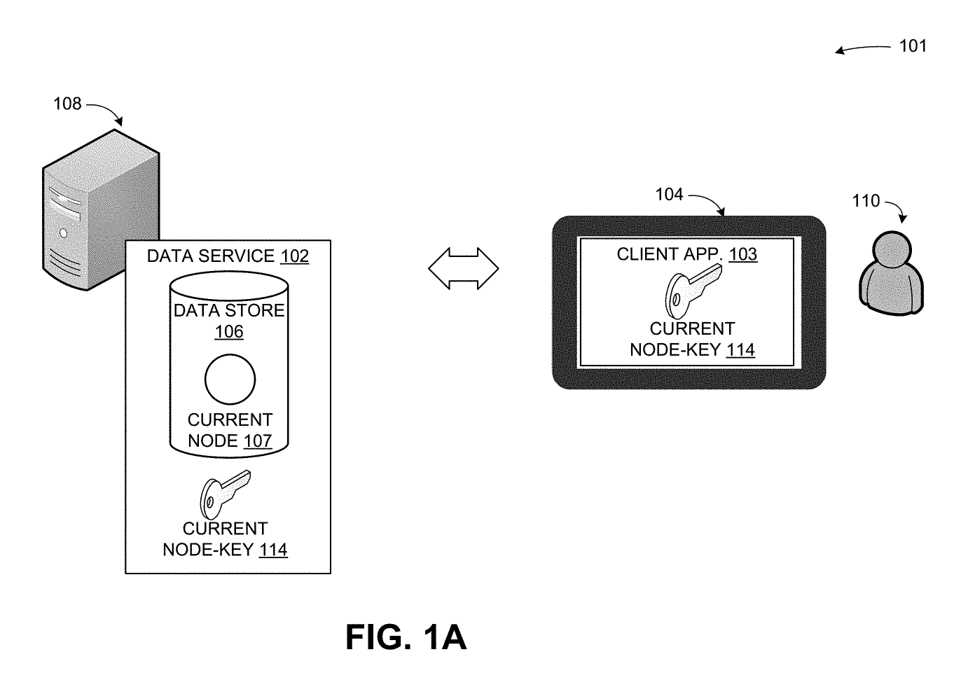

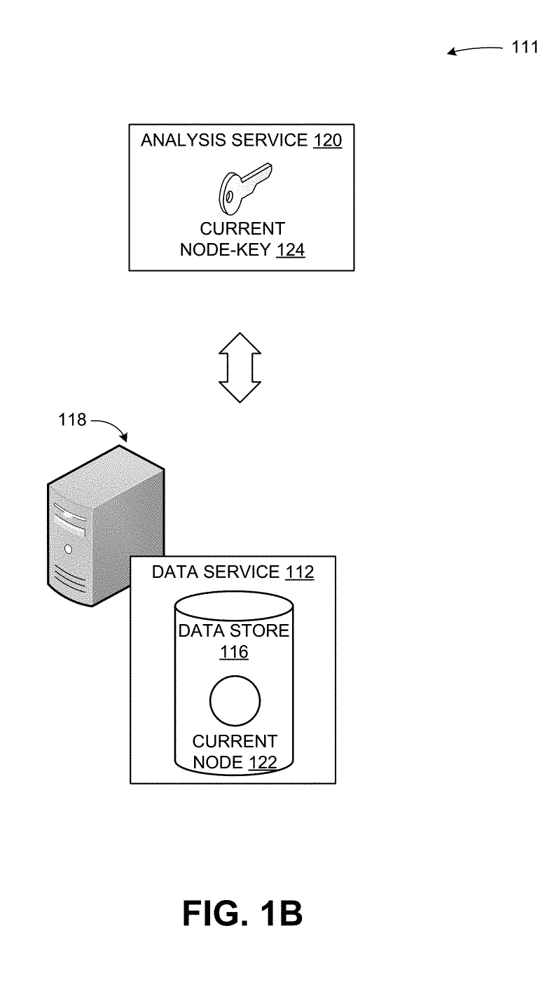

FIG. 1A through 1B are conceptual diagrams illustrating examples of constructing a filterable hierarchy based on a multidimensional key, according to embodiments.

In a diagram 101, a server 108 may execute a data service 102. The server 108 may include a physical server providing service(s) and/or application(s) to client devices. A service may include an application performing operations in relation to a client application and/or a subscriber, among others. The server 108 may include and/or is part of a workstation, a data warehouse, and/or a data center, among others.

The server 108 may execute the data service 102. The data service 102 may initiate operations to construct a filterable hierarchy based on a multidimensional key upon a request to generate a current node-key 114 of a current node 107 stored within a data store 106. The current node 107 may store data associated with an entity such as an event based data. The data may include components such as elements that include attributes of the node as well as identifier components associated with the node. Examples of identifier components may include a correlation identifier (ID) used for grouping related entities, an instance ID that refers to the entity represented by the current node 107, and/or a parent instance ID that refers to a parent node of the current node 107.

The current node 107, the parent node, and other children nodes of the parent node may be stored in a table based data structure. The hierarchy may be created by generating and inserting node-keys as elements into each row that represent the current node 107, the parent node, and other children nodes of the parent node. A key may be generated through a filtering process which selects a subset of the filterable elements of the node to concatenate into the key. A representation of the current node includes a current node-key (that includes filterable elements of the current node, child node(s), and a parent node, any children of the parent node), a parent node-key (that includes filterable elements of the parent node and/or filterable elements of children of the parent node), among other keys that include customized selection of elements of the current node 107. As such, the table based data structure builds a hierarchy from the current-node to the parent-node in a bottom to top scheme. The bottom to top nature of the data structure allows for implementation in a map reduce system and environments that consume map reduce type data. Furthermore, in some scenarios, the current node may have multiple parent nodes. In such a scenario, multiple parent node-keys may be generated similar to how a single parent node-key is generated. The multiple parent node-keys may be inserted into the representation of the current node.

Attributes of the node may include elements which may also be referred to as filters. The filterable elements may include a name, a subtype, a metadata, a binary attribute (such as is successful for a node that includes event based data), a data source, a datacenter, an agent name, a server role, and/or a localized content, among others. The filterable elements may be used to filter the current node 107 from a set of nodes by searching the set of nodes with part or all of the filterable elements of the current node 107. The previous examples of a structure of the current node 107 were not provided in a limiting sense. Indeed, alternative structures for identifiers and attributes may be used to store data in the current node 107.

The data service 102 may retrieve and join current node elements of the current node 107 with an element delimiter into a current node string. The element delimiter may include a vertical bar character, among others. Elements without character data types may be converted to strings. Next, the data store 106 may be queried for child node(s) of the current node 107. Child node elements may be retrieved and joined with the element delimiter into child node string(s). The child node string(s) may be encapsulated with nesting delimiter(s) (such as a bracket character, a braces character, and/or similar ones). A number of the nesting delimiter(s) may be correlated to a number of levels between the current node 107 and the child node(s). The child node string(s) may be concatenated to the current node string to construct an initial part of the current node-key 114.

Next the data service 102 may query the data store 106 to identify a parent node of the current node 107. Parent node elements may also be queried and retrieved from the data store 106. The parent node elements may be joined with the current node string (that includes the child node string(s)) with a parent delimiter (such as a hyphen character, among others). The current node string (that includes the child node string(s) and the parent node string) may be provided as the current node-key 114. The current node-key 114 may be inserted into a representation for the current node 107 (such as a row of a tabular data structure e.g.: a table) within a data structure (such as the tabular data structure). The current node-key 114 may be provided to a client application 103 of the data service 102 for a presentation to a stakeholder 110. A client device 104 may render the client application 103. The stakeholder 110 may include an administrator of the data service 102 and/or a consumer of the current node 107, among others.

The server 108 may communicate with the client device 104 through a network. The network may provide wired or wireless communications between network nodes such as the client device 104, or the server 108, among others. Previous example(s) to construct a filterable hierarchy based on a multidimensional key are not provided in a limiting sense. Alternatively, the data service 102 may manage the data store 106 at a desktop application, a workstation application, and/or a server application, among others. The client application 103 may also include a client interface of the data service 102.

The stakeholder 110 may interact with the client application 103 with a keyboard based input, a mouse based input, a voice based input, a pen based input, and a gesture based input, among others. The gesture based input may include one or more touch based actions such as a touch action, a swipe action, and a combination of each, among others.

In a diagram 111 of FIG. 1B, the data service 112 (executing in a server 118) may interact with an analysis service 120 to construct a current node-key 124 for a current node 122 stored in a data store 116. The analysis service 120 may include a third party service provider. The analysis service 120 may also execute operations to construct the current node-key 124. The analysis service 120 may join elements of the current node 122, child node(s) of the current node 122, and a parent node of the current node 122 into the current node-key 124.

The analysis service 120 may convert the current node-key 124 to a hash to reduce the length of a long node-key to a fixed length hash or a variable length hash. The fixed length or variable length hash may reduce resource consumption while processing the hash compared to processing a long node-key. Furthermore, the analysis service 120 may convert the current node-key 124 to a hash to remove any private data associated with the current node 122. Furthermore, the analysis service 120 may provide the current node-key 124 to an administrator of the data store 116, a stakeholder associated with the current node 122, and/or a consumer of the current node 122, among others.

While the example systems in FIG. 1A through 1B have been described with specific components including the server 108, the data service 102, embodiments are not limited to these components or system configurations and can be implemented with other system configuration employing fewer or additional components.

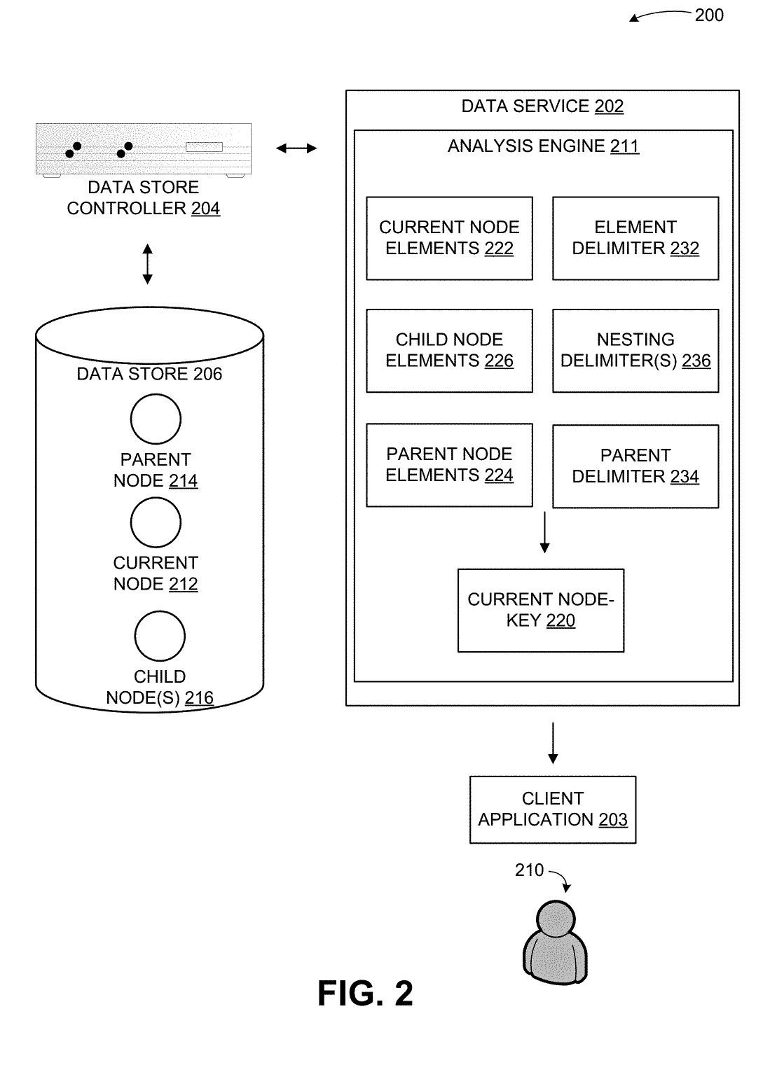

FIG. 2 is a display diagram illustrating example components of a data service that constructs a filterable hierarchy based on a multidimensional key, according to embodiments.

In a diagram 200, a data service 202 may receive a request for a current node-key 220 of a current node 212 from an entity such as a client application 203 or a third party provider. The current node-key 220 may provide a hierarchical representation of data associated with the current node 212, child node(s) 216 of the current node 212, and a parent node 214. As such, the current node-key 220 may describe relationship(s) between the current node 212, the child node(s) 216, and the parent node 214.

An analysis engine 211 of the data service 202 may execute a get current node-key scheme to start operations to query a data store 206 for current node elements 222 of the current node 212. The get current node-key scheme may include operation(s) to generate the current node-key 220. The analysis engine 211 may submit the query to a data store controller 204. The data store controller 204 may include hardware and software components specially purposed to interpret incoming queries, submit instructions to the data store 206 to retrieve the current node elements 222, and transmit the current node elements 222 to the analysis engine 211 for processing. The current node elements 222 may include identifiers associated with the current node 212 (such as a correlation ID, an instance ID, and/or a parent instance ID, among others) and attributes of the current node 212 (such as a name, a subtype, a metadata, a binary attribute, a data source, a datacenter, an agent name, a server role, a localized content, and/or similar ones). The analysis engine 211 may join the current node elements 222 with an element delimiter 232 into a current node string. An example of the element delimiter may include a vertical bar character.

The data service 202 may also execute a get child node string(s) scheme to start operations to query the data store 206 for child node elements 226 of child node(s) 216 of the current node 212. The get child node string(s) scheme may include operations to generate child node string(s). Child node elements 226 that include identifier and attributes may be received from the data store 206 through the data store controller 204. The child node elements 226 may also be joined with the element delimiter 232 into the child node string(s). Furthermore, the child node string(s) may be encapsulated with nesting delimiter(s) 236 (such as a bracket character, and/or a braces character, among others). A number of the nesting delimiter(s) 236 used to encapsulate the child node string(s) may be correlated to a number of levels between the child node(s) 216 and the current node 212. For example, child node string(s) of the child node(s) 216 may be identified as two levels below the current node 212 (with another child node between the current node 212 and the child node(s) 216). In such a scenario, the child node string(s) may be encapsulated with two sets of the nesting delimiter(s) 236 to indicate the relationship between the current node 212 and the child node(s) 216.

The analysis engine 211 may also query the data store 206 for a parent node 214 (of the current node 212) through the data store controller 204. In response to detecting the parent node 214, parent node elements 224 may be retrieved from the data store 206 using the get parent node string scheme on the parent node 214. The get parent node string scheme may include operations to generate a parent node string. The parent node elements 224 may similarly be joined with the element delimiter 232 into the parent node string. However, to distinguish a relationship between the current node 212 and the parent node 214, the parent node string may be concatenated to the current node string (that includes the child node string(s)) with a parent delimiter 234. The parent delimiter 234 may include a hyphen character, among others. The current node-key 220 may be generated from the current node string that includes the child node string(s) and the parent node string.

If the data store 206 returns a null value for the parent node (no parent node exists for the current node 212), an empty string may be used as the parent node string when constructing the current node-key 220. A lack of the parent node string within the current node-key 220 may be interpreted as a lack of the parent node 214 for the current node 212. In such a scenario, the current node 212 is interpreted as a root node.

Similarly, if the data store 206 returns a null value for the child node(s) (of the current node 212), an empty string may be used as the child node string(s) when constructing the current node-key 220. A lack of the child node string(s) within the current node-key 220 may be interpreted as a lack of the child node(s) 216 for the current node 212 or an end to child node(s) branch(es) below the current node 212.

The current node-key 220 may be provided to a client application 203 for rendering a hierarchy associated with the current node 212 to a stakeholder 210. The hierarchy may include the current node 212, the parent node 214, and/or the child node(s) 216, among others.

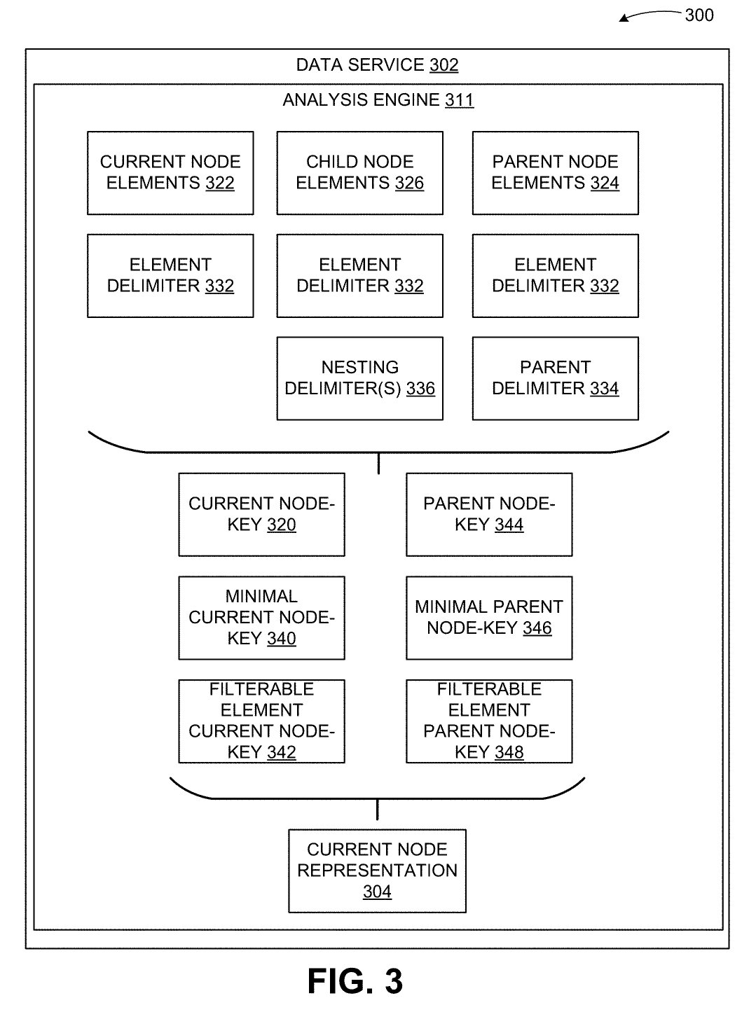

FIG. 3 is a display diagram illustrating components of a scheme to construct a filterable hierarchy based on a multidimensional key, according to embodiments.

In a diagram 300, an analysis engine 311 of a data service 302 may receive a request to generate a current node-key 320 from current node elements 322, child node elements 326, and parent node elements 324. The analysis engine 311 may execute a get current node-key scheme to generate the current node-key 320. The get current node-key scheme may include operation(s) to gather node elements, construct node strings, and concatenate the node strings to a current node key. The analysis engine 311 may also execute a get child node string scheme to query and retrieve child node elements 326. The get child node string scheme may include operations to generate the child node string(s). Furthermore, the analysis engine 311 may execute a get parent node string scheme to generate a parent node string. Re-use of the get current node-key scheme, get child node string scheme, and get parent node string scheme continually to retrieve node elements may allow a use of dedicated hardware customized for the get current node-key scheme, get parent node string scheme, the get child node string scheme. Such a configuration may save resources and performance by executing majority of key generation operations in custom dedicated hardware and allocating general computing resources for other operations.

The analysis engine 311 may join the current node elements 322 into a current node string, child node elements 326 into child node string(s), and the parent node elements 324 into a parent node string using element delimiter 332. Furthermore, the child node string(s) may be encapsulated with nesting delimiter(s) 336 that correlates to a number of levels between the child node(s) and the current node. The current node-key 320 may be generated by concatenating the child node string(s) to the current node string and further concatenating the parent node string to the resulting string with a parent delimiter 334.

Characters for the element delimiter 332, the nesting delimiter(s) 336, and/or the parent delimiter 334 may be selected by analyzing node elements and by confirming absence of the characters in the node elements. Another set of characters for element delimiter 332, the nesting delimiter(s) 336, and/or the parent delimiter 334 may be selected upon finding the characters in the node elements. A character selected as a delimiter (such as a hyphen character which may be found in the strings) may be used as the delimiter(s) as long as the selected character is replaced with another character (not found in the strings) before adding as delimiter(s) (for example, replace the hyphen character with an underscore character and use the hyphen character as a delimiter).

The analysis engine 311 may replace a null value returned from the data store for any one of the child node elements 326 and the parent node elements 324 with an empty string. The current node may be interpreted as a root node upon detecting a lack of the parent node string within the current node-key 320. The current node may be interpreted as lacking child node(s) if the current node-key 320 lacks the child node string(s). Alternatively, a lack of the child node string(s) below another child node string within the current node-key 320 may be interpreted as an end of child node branch(es).

Any non-character type data located within the current node elements 322, the child node elements 326, and/or the parent node elements 324 may be converted to a string based data with a string builder scheme, among others. Furthermore, the current node elements 322, the child node elements 326, and/or the parent node elements 324 may be converted to upper case characters, lower case characters, a standardized format of characters for a case sensitive comparison, a case insensitive comparison, and/or other standardized comparison of the current node-key 320 during a hierarchy visualization. Content of the node element(s) may also be converted for improved readability of the current node-key 320.

A current node representation 304 of a current node may include keys in addition to the current node-key 320. A parent node-key 344 may be generated for the current node representation 304 by executing the get parent node string scheme on the parent node and the get child node string scheme on the parent node. The parent node string that results from operations to join the parent node elements 324 and child node elements for the parent node may be used as the parent node-key 344.

Minimal keys for both the current node and the parent node may be generated to provide a hierarchy associated with the current node without a lengthy string to parse as a key representing the hierarchy which may reduce processing time, power, and/or resources, among other advantages. Furthermore, alternative minimal keys may be generated for the current node and the parent node based on filtering a selection of elements for each. For example, a custom minimal current node-key may be created for a consumer based on filtering of a selection of the filterable elements from the current-node as requested by the consumer. Similarly, a custom minimal parent node-key may be created for a stakeholder based on a filtering of a selection of the filterable elements from the parent-node as requested by the stakeholder. For example, data security may be managed by filtering elements of the current node and/or the parent node accessible by the consumer and/or a stakeholder to generate the minimal current node-key and/or the minimal parent node-key. In certain scenario, different minimal keys may be provided to different stakeholders based on configuration expected or available to each of the stakeholders.

A minimal current node-key 340 may be generated by concatenating a subset of the current node elements 322. An example of the subset may exclude localized content which may reduce a size of the minimal current node-key 340. Similarly, a minimal parent node-key 346 may be generated by concatenating a subset of the parent node elements 324. An example of the subset may exclude localized content which may also reduce a size of the minimal parent node-key 346.

Furthermore, filterable element keys (such as name key) for both the current node and the parent node may be generated to provide the hierarchy with just a single element of the nodes. A filterable element key (such as a name key) may allow for filtering of nodes based on individual elements associated with nodes which aid with visualization of the hierarchy of nodes. Furthermore, individual filterable elements (such as a name element) of the current node, the child node(s), and the parent node may be concatenated with nesting delimiter(s) 336 and the parent delimiter 334 to generate the filterable element current node-key 342 similar to how the current node-key 320 is generated. Alternatively, the current node-key 320, the minimal current node-key 340, and/or the filterable element current node-key 342 may be generated with delimiters that have characters that vary for each of the keys. Similarly, a parent node-key 344, a minimal parent node-key 346, and/or a filterable element parent node-key 348 may be generated with delimiters that have characters that vary for each of the keys.

In addition, the filterable element parent node-key 348 may be generated by concatenating a filterable element of the parent node with filterable elements of child node(s) of the parent node with the nesting delimiter(s) 336 similar to how the parent node-key 344 is generated. The current node-key 320, the minimal current node-key 340, the filterable element current node-key 342, the parent node-key 344, the minimal parent node-key 346, and/or the filterable element parent node-key 348 are inserted into the current node representation 304 to provide and distinguish the hierarchy associated with the current node through the keys stored in the current node representation 304. Furthermore, the representation of the current node may include other minimal current node-keys and/or other minimal parent node-keys generated with a selection of other filterable elements of the current node and/or parent node. The representation of the current node may also include other filterable element current node-keys and/or other filterable element parent node-keys generated with any of the filterable elements of the current node and/or parent node.

A size of the current node-key 320 may be limited by truncating and/or limiting a size of the child node string(s). An example may include limiting a number of levels of child node elements within the child node string(s). Another example may include limiting the number of child node elements nested directly (such as at the same level) below a given node element. The size of the current node-key 320 may be limited to manage an error scenario associated with an extensive size that the current node-key 320 may reach. An extensive size may use up available memory resources and limit processing that may be done with the current node-key 320.

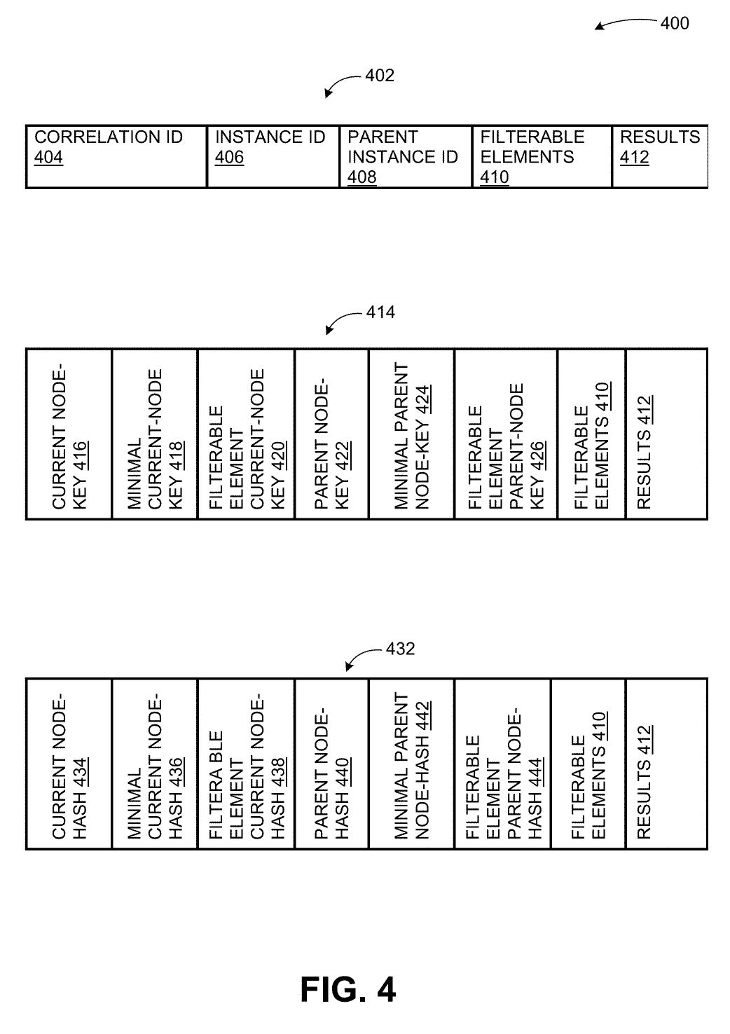

FIG. 4 is a display diagram illustrating tabular data structures that store keys and components used to represent a node of a data store, according to embodiments.

In a diagram 400, a data service may process elements of a current node to generate a condensed representation 402 of the current node. For example, the condensed representation 402 may include a correlation ID 404 that establishes a relationship between nodes. Each node that shares the correlation ID 404 is related. For example, a parent node of the current node may share the correlation ID 404. Similarly, child node(s) of the current node may share the correlation ID. An instance ID 406 may be a unique identifier assigned to the current node. A parent instance ID 408 may be a unique identifier assigned to the parent node of the current node.

The parent node may be located with an operation associated with sequence numbers assigned to each node within a cluster that share the correlation ID 404. Candidate parent node(s) may be found by selecting a subset of nodes that have a higher sequence number than a sequence number of the current node. A candidate parent node with a highest sequence number among the candidate parent node(s) is selected as the parent node for the current node.

As discussed previously, a representation 414 of a data structure may describe one or more relationships and the data of the current node. The representation 414 may include the current node-key 416, minimal current node-key 418, filterable element current node-key 420, parent node-key 422, minimal parent node-key 424, filterable element parent node-key 426, filterable elements 410, and/or results 412. The results 412 may include measurements associated with interactions related to the current node. For example, an event based node may include duration (of the event) measurements within the results 412.

Outlier computations may be done using values captured in the results 412 by comparing the values to expected range(s). Outlier computation(s) that exceed threshold(s) may be used to label the node as an outlier compared to other nodes within a set that share the filterable element current node-key 420 (or the filterable element current node-hash 438). Alternatively, outlier detection may be computed with other filterable elements of the current node, such as a name element and/or a correlation ID 404. For example, if the current node shares a name element from the filterable elements 410 with another node then the current node may be marked as an outlier, after executing the relevant outlier detection logic. A subset of the filterable elements 410 and/or all of the filterable elements 410 of the current node may be used to detect outliers.

Furthermore, a hash representation 432 of the current node may be generated by converting the keys of the representation 414 to hashes. Hash conversions of the keys may be done to encrypt the keys of the representation 414 and/or to limit a size of the entity used to represent the current node. A condensed entity has such as a current node-hash 434, a minimal current node-hash 436, a filterable element current node-hash 438, a parent node-hash 440, a minimal parent node-hash 442, and/or a filterable element parent node-hash 444 may be used instead of the keys in the representation 414. Furthermore, the representation 414 and the hash representation 432 of the current node may include other minimal current node-keys, other minimal parent node-keys, other minimal current node-hashes, and/or other minimal parent node-hashes generated with a selection of other filterable elements of the current node and/or the parent node. The representation of the current node may also include other filterable element current node-keys, other filterable element parent node-keys, other filterable element current node-hashes and/or other filterable element parent node-hashes generated with any of the filterable elements of the current node and/or parent node.

The hashes may simplify communications and references to the current node and/or the parent node. The hashes may also be decrypted to restore a corresponding key of the representation 414. Alternatively, the current node-hash 434 or any of the other hashes in the hash representation 432 may be used to refer to the associated key or the representation 414. For example, the current node-hash 434 may be provided instead of the current node-key 416 to simplify processing of the representation 414 of the current node. An authorized stakeholder may access the current node-key 416 with the current node-hash 434. The hashes in the hash representation 432 may be provided instead of the keys in the representation 414 to minimize presented content compared to an entirety of a key with in the representation 414.

An example of the current node-key 416 may include:

```
      [AUTHENTICATION_RETRIEVEIDENTITY|||1|PRODUCTION|CUS|RETAILER
STOREFRONTAGENT|STOREFRONT|]
      [COMMERCECOUNTERS_CREATEACCOUNT|||1|PRODUCTION|CUS|RETAILER
STOREFRONTAGENT|STOREFRONT|
        [SERVICECALLCACHING_GETSERVICECALL|||1|PRODUCTION|CUS|
RETAILERSTOREFRONTAGENT|STOREFRONT|]
        [SERVICECALLCACHING_SAVESERVICECALL|||1|PRODUCTION|
CUS|RETAILERSTOREFRONTAGENT|STOREFRONT|
          [DATABASE_STRINGSET|COSUB||1|PRODUCTION|CUS|RETAILER
STOREFRONTAGENT|STOREFRONT|]
        ]
      ]
      [COMMERCECOUNTERS_GETACCOUNTID|||1|PRODUCTION|CUS|RETAILER
STOREFRONTAGENT|STOREFRONT|
        [SERVICECALLCACHING_GETSERVICECALL|||1|PRODUCTION|CUS|
RETAILERSTOREFRONTAGENT|STOREFRONT|
          [DATABASE_STRINGGETWITHEXPIRY|COSUB||1|PRODUCTION|
CUS|RETAILERSTOREFRONTAGENT|STOREFRONT|]
      ]
      [SERVICECALLCACHING_SAVESERVICECALL|||1|PRODUCTION|
CUS|RETAILERSTOREFRONTAGENT|STOREFRONT|
          [DATABASE_STRINGSET|COSUB||1|PRODUCTION|CUS|RETAILER
STOREFRONTAGENT|STOREFRONT|]
        ]
      ]
    ]
]
```

The current node-key 416 may include the following elements:

Name: PROVISION_GETACCOUNTID
Subtype: PROVISION
Metadata: None
Is Successful?: True
Data Source: PRODUCTION
Datacenter: CUS
Agent Name: RETAILERSTOREFRONTAGENT
Server Role: STOREFRONT
Content Locale: None (perhaps a backend task)

The filterable elements of the current node may be concatenated with one or more element delimiters “|”. The current node-key 416 may also have a single child node PROVISION_ACCOUNTIDRETRIEVALACTION. The string that represents the child node may be encapsulated with the nesting delimiter “[” or “]”. The child node may have children nodes named AUTHENTICATION_RETRIEVEIDENTITY, COMMERCECOUNTERS_CREATEACCOUNT, and COMMERCECOUNTERS_GETACCOUNTID. The latter two children nodes may have additional child nodes.

After the parent delimiter “|-|” an example of the parent node-key 422 may be inserted into the current node-key. The parent node-key 422 may have a filterable element of PROVISIONOFFERSERVICE_GETACCOUNTID. The parent node-key 422 may have a single child node which includes the filterable element of the current node of PROVISION_GETACCOUNTID. Examples of the element delimiter, the nesting delimiter(s), and/or the parent delimiter were not used in a limiting sense. Indeed other characters may be used for each of the delimiters and/or varying characters may be used for delimiters for strings that represent the current node, the parent node, and/or the children nodes.

As discussed above, the data service may be employed to perform operations to automate constructing a filterable hierarchy based on a multidimensional key. An increased user efficiency with the client application 103 may occur as a result of processing a current node through the data service 102 and generating a current node-key to represent a hierarchy of the current node. The current node-key may include a concatenated string of each node within a hierarchy of the current node. Additionally, processing the current node, by the data service 102, may reduce processor load, increase processing speed, conserve memory, and reduce network bandwidth usage.

Embodiments, as described herein, address a need that arises from a lack of efficiency to construct a filterable hierarchy based on a multidimensional key. The actions/operations described herein are not a mere use of a computer, but address results that are a direct consequence of software used as a service offered to large numbers of users and applications.

The example scenarios and schemas in FIG. 1A through 4 are shown with specific components, data types, and configurations. Embodiments are not limited to systems according to these example configurations. Constructing a filterable hierarchy based on a multidimensional key may be implemented in configurations employing fewer or additional components in applications and user interfaces. Furthermore, the example schema and components shown in FIG. 1A through 4 and their subcomponents may be implemented in a similar manner with other values using the principles described herein.

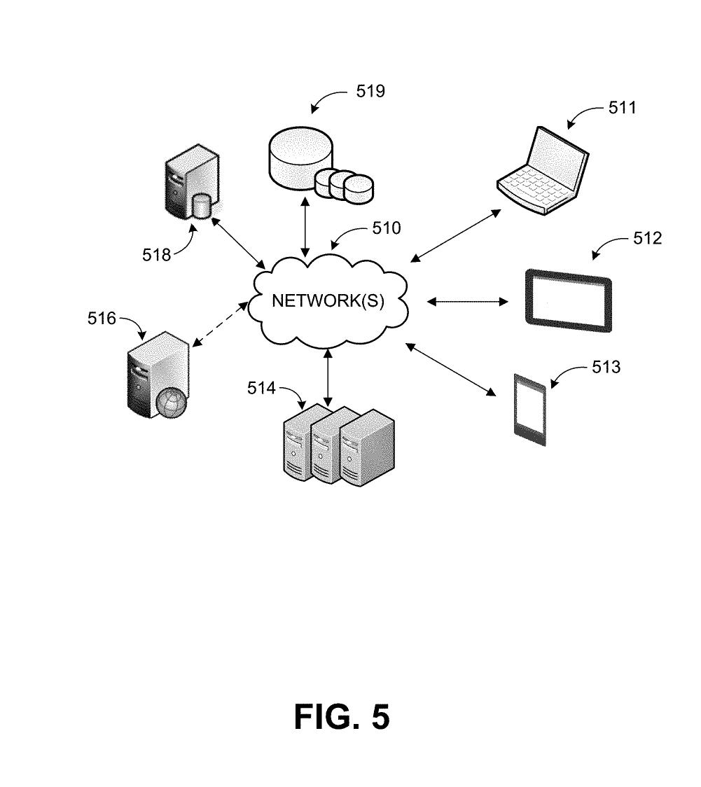

FIG. 5 is an example networked environment, where embodiments may be implemented. A data service configured to construct a filterable hierarchy based on a multidimensional key may be implemented via software executed over one or more servers 514 such as a hosted service. The platform may communicate with client applications on individual computing devices such as a smart phone 513, a mobile computer 512, or desktop computer 511 (client devices′) through network(s) 510.

Client applications executed on any of the client devices 511-513 may facilitate communications via application(s) executed by servers 514, or on individual server 516. A data service may join current node-key elements with an element delimiter into a current node string. Child node elements may also be joined with the element delimiter into child node string(s). The child node string(s) may be encapsulated with nesting delimiter(s) and the resulting string may be concatenated to the current node string. Next, parent node elements may be joined with the element delimiter. The current node-key may be generated by concatenating the parent node string to the current node string (that includes the child node string) with a parent delimiter. The current node-key may be inserted into a representation for the current node within a data structure. The data service may store data associated with the current-node in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to construct a filterable hierarchy based on a multidimensional key. Furthermore, the networked environments discussed in FIG. 5 are for illustration purposes only. Embodiments are not limited to the example applications, modules, or processes.

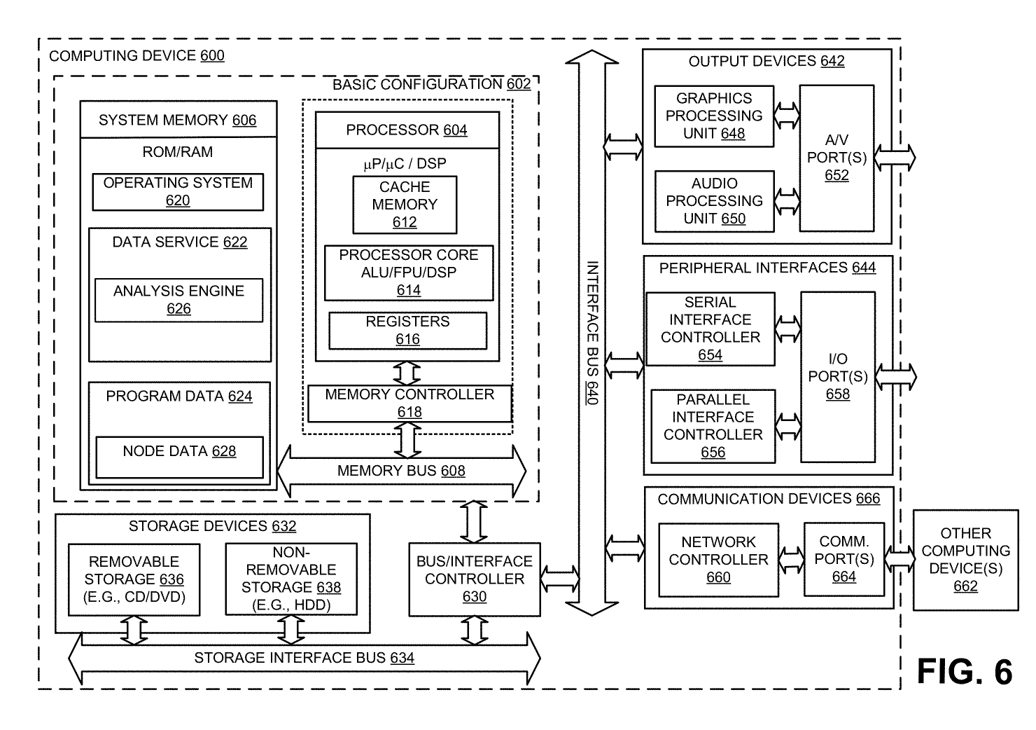

FIG. 6 is a block diagram of an example computing device, which may be used to construct a filterable hierarchy based on a multidimensional key, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a data service 622, and a program data 624. The data service 622 may include components such as an analysis engine 626. The analysis engine 626 may execute the processes associated with the data service 622. The analysis engine 626 may join current node-key elements with an element delimiter into a current node string. Child node elements may also be joined with the element delimiter into child node string(s). The child node string(s) may be encapsulated with nesting delimiter(s) and the resulting string may be concatenated to the current node string. Next, parent node elements may be joined with the element delimiter. The current node-key may be generated by concatenating the parent node string to the current node string (that includes the child node string) with a parent delimiter. The current node-key may be inserted into a representation for the current node within a data structure.

Input to and output out of the data service 622 may be transmitted through a communication device associated with the computing device 600. An example of the communication device may include a networking device that may be communicatively coupled to the computing device 600. The communication device may provide wired and/or wireless communication. The program data 624 may also include, among other data, node data 628, or the like, as described herein. The node data 628 may include identifiers, attributes, and/or results, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to construct a filterable hierarchy based on a multidimensional key. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

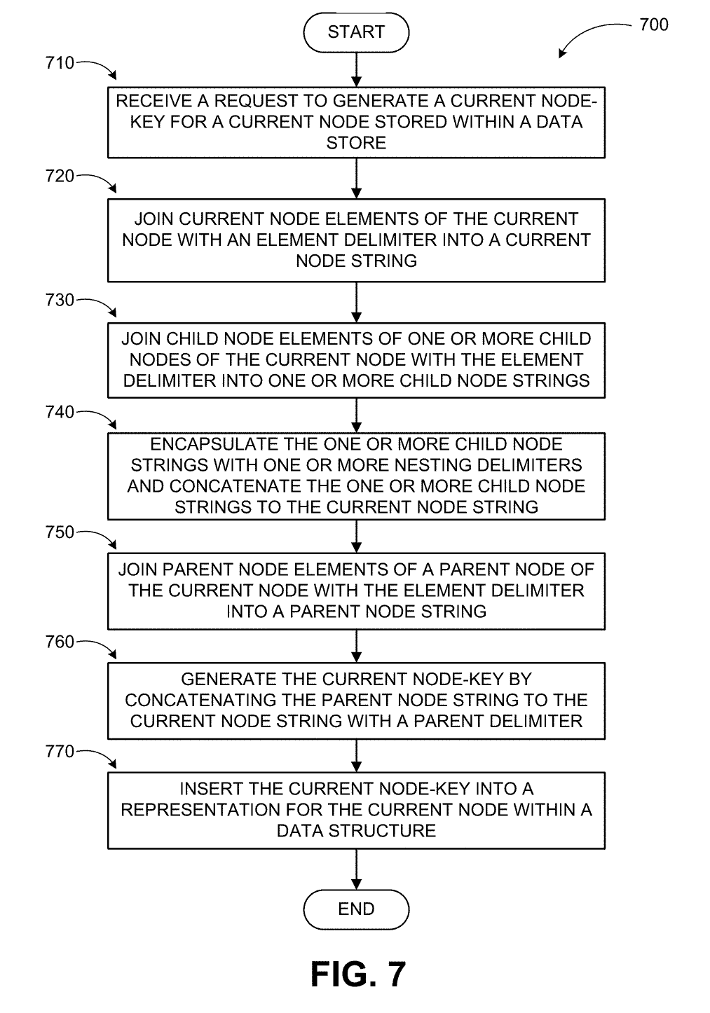

FIG. 7 is a logic flow diagram illustrating a process for constructing a filterable hierarchy based on a multidimensional key, according to embodiments. Process 700 may be implemented on a computing device, such as the computing device 600 or another system.

Process 700 begins with operation 710, where the data service receives a request to generate a current node-key for a current node stored within a data store. Next, at operation 720, current node elements of the current node may be joined with an element delimiter into a current node string. The element node string may include a vertical bar character. At operation 730, child node elements of child node(s) (of the current node) may be joined with the element delimiter into child node string(s). The child node(s) may be nested.

At operation 740, the child node string(s) may be encapsulated with nesting delimiter(s) and concatenated to the current node string. The nesting delimiter(s) may include a set of bracket characters and/or brace characters. Next, at operation 750, parent node elements may be joined with the element delimiter into a parent node string. The current node-key may be generated by concatenating the parent node string to the current node string (that includes the child node string(s)) with a parent delimiter at operation 760. The parent delimiter may include a hyphen character. The current node-key may be inserted into a representation for the current node within a data structure at operation 770.

The operations included in process 700 is for illustration purposes. Constructing a filterable hierarchy based on a multidimensional key may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a server to construct a filterable hierarchy based on a multidimensional key is described. The server includes a data store controller, a memory configured to store instructions associated with a data service, and processor(s) coupled to the memory and the data store controller. The processor(s) executes the data service in conjunction with the instructions stored in the memory. The data service includes an analysis engine. The analysis engine is configured to receive a request to generate a current node-key for a current node stored within a data store, join current node elements of the current node with an element delimiter into a current node string, join child node elements of one or more child nodes of the current node with the element delimiter into one or more child node strings, encapsulate the one or more child node strings with one or more nesting delimiters and concatenate the one or more child node strings to the current node string, join parent node elements of a parent node of the current node with the element delimiter into a parent node string, generate the current node-key by concatenating the parent node string to the current node string with a parent delimiter, and insert, through the data store controller, the current node-key into a representation for the current node within a data structure.

In other examples, the analysis engine is further configured to detect one or more lower child nodes of the one or more child nodes, join lower child node elements of the one or more lower child nodes with the element delimiter into one or more lower child node strings, encapsulate the one or more lower child node strings with a number of the one or more nesting delimiters, where the number of the one or more nesting delimiters corresponds to a number of levels between the one or more lower child nodes and the current node, and concatenate the one or more lower child node strings to the one or more child node strings. The analysis engine is further configured to query and retrieve the current node elements from the data store and in response to detecting a null value within a subset of the current node elements, replace the subset of the current node elements with an empty string.

In further examples, the analysis engine is further configured to query the data store to detect the one or more child nodes and in response to detecting the one or more child nodes, retrieve the child node elements from the data store and replace a subset of the child node elements that include a null value with an empty string, and in response to a failure to detect the one or more child nodes, providing an empty string as the one or more child node strings. The analysis engine is further configured to query the data store to detect the parent node and in response to detecting the parent node, retrieve the parent node elements from the data store and replace a subset of the parent node elements that include a null value with an empty string, and in response to a failure to detect the parent node, providing an empty string as the parent node string.

In other examples, the analysis engine is further configured to detect one or more of the element delimiter, the one or more nesting delimiters, and the parent delimiter within one or more of the current node elements, the child node elements, and the parent node elements and replace the one or more of the element delimiter, the one or more nesting delimiters, and the parent delimiter with an alternative character that is not found within the current node elements, the child node elements, and the parent node elements.

In further examples, the analysis engine is further configured to join a first subset of fields of the current node elements with an element delimiter into one or more minimal current node strings, join a second subset of fields of the child node elements with the element delimiter into one or more minimal child node strings, encapsulate the one or more minimal child strings with the one or more nesting delimiters and concatenate the one or more minimal child node strings to the one or more minimal current node strings, join a third subset of fields of the parent node elements with the element delimiter into one or more minimal parent node strings, generate one or more minimal current node-keys by concatenating the one or more minimal parent node strings to the one or more minimal current node strings with the parent delimiter, and insert, through the data store controller, the one or more minimal current node-keys into the representation for the current node within the data structure.

In other examples, the analysis engine is further configured to concatenate one or more child-node filterable elements of the one or more child nodes to a current-node filterable element of the current node with the element delimiter and generate a filterable element current node-key by concatenating a parent-node filterable element of the parent node to the current-node filterable element with the parent delimiter.

In further examples, the analysis engine is further configured to join other child node elements of one or more other child nodes of the parent node with the element delimiter into one or more other child node strings, encapsulate the one or more other child node strings with the one or more nesting delimiters, generate a parent node-key by concatenating the one or more other child node strings to the parent node string, and insert, through the data store controller, the parent node-key into the representation for the current node within the data structure. The analysis engine is further configured to join a first subset of fields of the parent node elements with an element delimiter into one or more minimal parent node strings, join a second subset of fields of the other child node elements with the element delimiter into one or more minimal other child node strings, encapsulate the one or more minimal other child strings with the one or more nesting delimiters, generate one or more minimal parent node-keys by concatenating the one or more minimal other child node strings to the one or more minimal parent node strings, and insert, through the data store controller, the one or more minimal parent node-keys into the representation for the current node within the data structure. The analysis engine is further configured to generate a filterable element parent node-key by concatenating a child-node filterable element of the one or more other child nodes to a parent-node filterable element of the parent node with the element delimiter.

In some examples, a method executed on a computing device to construct a filterable hierarchy based on a multidimensional key is described. The method includes joining current node elements of a current node with an element delimiter into a current node string, where the current node elements are retrieved from a data store storing the current node, joining child node elements of one or more child nodes of the current node with the element delimiter into one or more child node strings, where the child node elements are retrieved from the data store storing the one or more child nodes, encapsulating the one or more child node strings with one or more nesting delimiters and concatenate the one or more child node strings to the current node string, joining parent node elements of a parent node of the current node with the element delimiter into a parent node string, where the parent node elements are retrieved from the data store storing the parent node, generating a current node-key by concatenating the parent node string to the current node string with a parent delimiter, and inserting the current node-key into a representation for the current node within a data structure.

In other examples, the method further includes converting the current node elements, the child node elements, and the parent node elements to one of uppercase characters, lowercase characters, and a standardized representation of characters. The method further includes converting a binary element within the one or more of the current node elements, the child node elements, and the parent node elements into a string representation of a binary value.

In further examples, the method further includes executing a get current node-key scheme on the current node to generate the current node-key for the current node, wherein the current node string, the one or more child node strings, and the parent node string are concatenated to generate the current node-key. The method further includes in response to detecting the parent node, executing a get parent node string scheme on the parent node to generate the parent node string for the parent node and in response to a failure to detect the parent node, providing an empty string as the parent node string. The method further includes in response to detecting the one or more child nodes, executing a get child node scheme on the one or more child nodes to generate the one or more child node strings for the one or more child nodes and in response to a failure to detect the one or more child nodes, providing an empty string as the one or more child node strings.

In some examples, a computer-readable memory device with instructions stored thereon to construct a filterable hierarchy based on a multidimensional key is described. The instructions include actions similar to actions of the method. The instructions further include limiting a size of the current node-key by truncating or limiting a size of the one or more child node strings to manage an error scenario associated with the size of the current node-key. The instructions further include executing a hash scheme on the current node-key to convert the current node-key to a current node-hash and one of: adding the current node-hash as a reference to the current node-key into the representation for the current node and replacing the current node-key with the current node-hash.

In some examples, a means for constructing a filterable hierarchy based on a multidimensional key is described. The means for constructing the filterable hierarchy based on the multidimensional key includes a means for receiving a request to generate a current node-key for a current node stored within a data store, a means for joining current node elements of the current node with an element delimiter into a current node string, a means for joining child node elements of one or more child nodes of the current node with the element delimiter into one or more child node strings, a means for encapsulating the one or more child node strings with one or more nesting delimiters and concatenate the one or more child node strings to the current node string, a means for joining parent node elements of a parent node of the current node with the element delimiter into a parent node string, a means for generating a current node-key by concatenating the parent node string to the current node string with a parent delimiter, and a means for inserting the current node-key into a representation for the current node within a data structure.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A server to construct a filterable hierarchy based on a multidimensional key, the server comprising:
a data store controller;
a memory configured to store instructions associated with a data service;
one or more processors coupled to the memory and the data store controller, the one or more processors executing the data service in conjunction with the instructions stored in the memory, wherein the data service includes:
an analysis engine configured to:
receive a request to generate a current node-key for a current node stored within a data store;
join current node elements of the current node with an element delimiter into a current node string;
join child node elements of one or more child nodes of the current node with the element delimiter into one or more child node strings;
encapsulate the one or more child node strings with one or more nesting delimiters and concatenate the one or more child node strings to the current node string;
join parent node elements of a parent node of the current node with the element delimiter into a parent node string;
generate the current node-key by concatenating the parent node string to the current node string with a parent delimiter; and
insert, through the data store controller, the current node-key into a representation for the current node within a data structure.

2. The server of claim 1, wherein the analysis engine is further configured to:
detect one or more lower child nodes of the one or more child nodes;
join lower child node elements of the one or more lower child nodes with the element delimiter into one or more lower child node strings;
encapsulate the one or more lower child node strings with a number of the one or more nesting delimiters, wherein the number of the one or more nesting delimiters corresponds to a number of levels between the one or more lower child nodes and the current node; and
concatenate the one or more lower child node strings to the one or more child node strings.

3. The server of claim 1, wherein the analysis engine is further configured to:
query and retrieve the current node elements from the data store; and
in response to detecting a null value within a subset of the current node elements, replace the subset of the current node elements with an empty string.

4. The server of claim 1, wherein the analysis engine is further configured to:
query the data store to detect the one or more child nodes; and
in response to detecting the one or more child nodes,
retrieve the child node elements from the data store, and
replace a subset of the child node elements that include a null value with an empty string; and
in response to a failure to detect the one or more child nodes,
providing an empty string as the one or more child node strings.

5. The server of claim 1, wherein the analysis engine is further configured to:
query the data store to detect the parent node; and
in response to detecting the parent node,
retrieve the parent node elements from the data store, and
replace a subset of the parent node elements that include a null value with an empty string; and
in response to a failure to detect the parent node,
providing an empty string as the parent node string.

6. The server of claim 1, wherein the analysis engine is further configured to:
detect one or more of the element delimiter, the one or more nesting delimiters, and the parent delimiter within one or more of the current node elements, the child node elements, and the parent node elements; and
replace the one or more of the element delimiter, the one or more nesting delimiters, and the parent delimiter with an alternative character that is not found within the current node elements, the child node elements, and the parent node elements.

7. The server of claim 1, wherein the analysis engine is further configured to:
join a first subset of fields of the current node elements with an element delimiter into one or more minimal current node strings;
join a second subset of fields of the child node elements with the element delimiter into one or more minimal child node strings;
encapsulate the one or more minimal child strings with the one or more nesting delimiters and concatenate the one or more minimal child node strings to the one or more minimal current node strings;
join a third subset of fields of the parent node elements with the element delimiter into one or more minimal parent node strings;
generate one or more minimal current node-keys by concatenating the one or more minimal parent node strings to the one or more minimal current node strings with the parent delimiter; and
insert, through the data store controller, the one or more minimal current node-keys into the representation for the current node within the data structure.

8. The server of claim 1, wherein the analysis engine is further configured to:
concatenate one or more child-node filterable elements of the one or more child nodes to a current-node filterable element of the current node with the element delimiter; and
generate a filterable element current node-key by concatenating a parent-node filterable element of the parent node to the current-node filterable element with the parent delimiter.

9. The server of claim 1, wherein the analysis engine is further configured to:
join other child node elements of one or more other child nodes of the parent node with the element delimiter into one or more other child node strings;
encapsulate the one or more other child node strings with the one or more nesting delimiters;
generate a parent node-key by concatenating the one or more other child node strings to the parent node string; and
insert, through the data store controller, the parent node-key into the representation for the current node within the data structure.

10. The server of claim 9, wherein the analysis engine is further configured to:
join a first subset of fields of the parent node elements with an element delimiter into one or more minimal parent node strings;
join a second subset of fields of the other child node elements with the element delimiter into one or more minimal other child node strings;
encapsulate the one or more minimal other child strings with the one or more nesting delimiters;
generate one or more minimal parent node-keys by concatenating the one or more minimal other child node strings to the one or more minimal parent node strings; and
insert, through the data store controller, the one or more minimal parent node-keys into the representation for the current node within the data structure.

11. The server of claim 9, wherein the analysis engine is further configured to:
generate a filterable element parent node-key by concatenating a child-node filterable element of the one or more other child nodes to a parent-node filterable element of the parent node with the element delimiter.

12. A method executed on a computing device to construct a filterable hierarchy based on a multidimensional key, the method comprising:
joining current node elements of a current node with an element delimiter into a current node string, wherein the current node elements are retrieved from a data store storing the current node;
joining child node elements of one or more child nodes of the current node with the element delimiter into one or more child node strings, wherein the child node elements are retrieved from the data store storing the one or more child nodes;
encapsulating the one or more child node strings with one or more nesting delimiters and concatenate the one or more child node strings to the current node string;
joining parent node elements of a parent node of the current node with the element delimiter into a parent node string, wherein the parent node elements are retrieved from the data store storing the parent node;
generating a current node-key by concatenating the parent node string to the current node string with a parent delimiter; and
inserting the current node-key into a representation for the current node within a data structure.

13. The method of claim 12, further comprising:
converting the current node elements, the child node elements, and the parent node elements to one of uppercase characters, lowercase characters, and a standardized representation of characters.

14. The method of claim 12, further comprising:
converting a binary element within the one or more of the current node elements, the child node elements, and the parent node elements into a string representation of a binary value.

15. The method of claim 12, further comprising:
executing a get current node-key scheme on the current node to generate the current node-key for the current node, wherein the current node string, the one or more child node strings, and the parent node string are concatenated to generate the current node-key.

16. The method of claim 15, further comprising:
in response to detecting the parent node, executing a get parent node string scheme on the parent node to generate the parent node string for the parent node; and
in response to a failure to detect the parent node, providing an empty string as the parent node string.

17. The method of claim 15, further comprising:
in response to detecting the one or more child nodes, executing one or more get child node string schemes on the one or more child nodes to generate the one or more child node strings for the one or more child nodes; and
in response to a failure to detect the one or more child nodes, providing an empty string as the one or more child node strings.

18. A computer-readable memory device with instructions stored thereon to construct a filterable hierarchy based on a multidimensional key, the instructions comprising:
joining current node elements of a current node with an element delimiter into a current node string, wherein the current node elements are retrieved from a data store storing the current node;
joining child node elements of one or more child nodes of the current node with the element delimiter into one or more child node strings, wherein the child node elements are retrieved from the data store storing the one or more child nodes;
encapsulating the one or more child node strings with one or more nesting delimiters and concatenate the one or more child node strings to the current node string;
joining parent node elements of a parent node of the current node with the element delimiter into a parent node string, wherein the parent node elements are retrieved from the data store storing the parent node;
generating a current node-key by concatenating the parent node string to the current node string with a parent delimiter; and
inserting the current node-key into a representation for the current node within a data structure.

19. The computer-readable memory device of claim 18, wherein the instructions further comprise:
limiting a size of the current node-key by truncating or limiting a size of the one or more child node strings to manage an error scenario associated with the size of the current node-key.

20. The computer-readable memory device of claim 18, wherein the instructions further comprise:
executing a hash scheme on the current node-key to convert the current node-key to a current node-hash; and
one of:
adding the current node-hash as a reference to the current node-key into the representation for the current node; and
replacing the current node-key with the current node-hash.
